(19) United States
(12) Patent Application Publication
(10) Pub. No.: US 2021/0327149 A1
(43) Pub. Date: Oct. 21, 2021

(54) System and Method for Emotion-Based Real-Time Personalization of Augmented Reality Environments

(71) Applicant: Mach-3D SaRL, Luxembourg (LU)

(72) Inventors: Olivier Chandra de Keyser, Luxembourg (LU); Alessandro Ligi, Brussels (BE); Paolo Belardinelli, Monte Porzio Catone (IT); Leonid Mesentsev, Ardea (RM) (IT); Dmitrii Fomin, Limassol (CY)

(21) Appl. No.: 17/233,016

(22) Filed: Apr. 16, 2021

Related U.S. Application Data
(60) Provisional application No. 63/010,842, filed on Apr. 16, 2020.
(60) Provisional application No. 63/054,778, filed on Jul. 21, 2020.

(51) Int. Cl. G06T 19/00; G06K 9/00; G06T 19/20

(52) U.S. Cl. CPC G06T 19/006; G06K 9/00302; G06T 2219/2012; G06K 9/00281; G06T 19/20; G06K 9/00255

(57) ABSTRACT

Systems and methods for emotion-based real-time personalization of augmented reality environments are disclosed. Exemplary implementations may: receive a series of original images of a user's face; detect, in the series of images, at least one emotion of the user; modify the series of images in response to the detected emotion(s); and display the modified images on a screen of the personal electronic device. In some embodiments, images may be modified based on one or more detected demographic characteristics of a user. In various implementations, processing may be done locally on a personal electronic device and the modified images displayed substantially in real-time.

### CROSS-REFERENCE TO RELATED APPLICATIONS

The present application claims priority to U.S. Provisional Patent Application Nos. 63/010,842, filed Apr. 16, 2020 and 63/054,778 filed Jul. 21, 2020, the contents of which are incorporated by reference herein in their entirety.

### TECHNICAL FIELD

This disclosure relates generally to technological improvements in the field augmented reality (“AR”). More specifically, the disclosure describes systems and method for providing an enhanced augmented reality platform including real-time personalization of face filters by analyzing emotions of a user and other characteristics of a user such as age, gender, or individual facial feature attributes.

### BACKGROUND

With the recent successes of chip miniaturization, the capabilities of even handheld computing devices such as smart phones to perform computing- and resource-intensive tasks such as video processing at a high level of quality have dramatically increased. Additionally, thanks to powerful central processing units (“CPUs”) and graphics processing units (“GPUs”), modern personal mobile devices include powerful software that materially improves video quality using, e.g. optical image stabilization, light correction, high-quality color modification filters, etc.

These improved capabilities are useful in many contexts and to many software applications, including augmented reality, extended reality, face filters, 3D interactive objects in an augmented reality environment, etc. Such software packages are traditionally unable to detect objects such as facial features and to interact with them in real-time.

Recent years have seen various apps that incorporate AR face filters become incredibly popular with consumers, particularly as a form of entertainment on a smartphone or other personal electronic device. Their engaging and entertaining features also make such apps an attractive target for advertisers who wish to have their products considered by the user of an AR filter. Advertisers may, in some instances, pay millions of dollars per day for a prominent advertising spot in a popular application.

AR face filters are also sometimes used by brands to deliver personal experiences to their customers in the hope of promoting brand loyalty and ease of try-on of various styles of headwear, eyewear, or cosmetics, for example when buying eyeglasses, a user may see a rendering of several different pairs of glasses before making a purchase commitment. The present disclosure relates to methods and systems for providing a personalization based on a customer's emotions or other characteristics of a user.

### SUMMARY

In general, the present disclosure provides an enhanced augmented reality experience whereby a virtual environment is personalized using detected emotions, demographic characteristics, or other individual parameters of a user of the system. In one conception of the invention, a user would face a camera of a PC or the user's smartphone and the user would simultaneously view their own face on a screen in real-time, almost as if looking into a virtual mirror. A face and/or body tracking algorithm would identify facial and/or body landmarks and build a 3D digital model of detected features. An AR graphics layer would be applied to the face and/or body and positioned with precision thanks to the landmark-based 3D digital model. The colors, shape and design, or representation of an accessory of the AR graphics layer can be determined in whole or in part based on detected emotions or other characteristics of the user.

One aspect of the present disclosure relates to a system comprising a personal electronic device operated by a user, the system comprising one or more hardware processors of the personal electronic device configured by machine-readable instructions to receive a series of original images of the user's face; detect, in the series of images, at least one emotion and/or a demographic characteristic of the user; in response to the at least one detected emotion and/or demographic characteristic of the user, modify at least a portion of at least one image of the series of images of the user's face; and display, on a screen of the personal electronic device, the modified images of the series of images of the user's face.

According to some embodiments of the system, the modified images of the series of images of the user's face are displayed in substantially real-time. According to some embodiments of the system, at least one video capture device may be associated with the personal electronic device, the at least one video capture device configured to acquire at least some of the series of original images of the user's face.

In some implementations of the system, the series of original images of the user's face may comprise at least a portion of a pre-recorded video of the user's face. In some implementations of the system, modifying the video or series of images of the user's face comprises including at least one color associated with the at least one detected emotion of the user.

In some implementations of the system, modifying the video of the user's face comprises at least one of the following: a color modification, an animation, and an addition of an object to at least one image of the series of images of the user's face.

In some implementations of the system, modifying at least a portion of at least one image of the series of images of the user's face comprises applying a new visual layer to the at least one of the series of images of the user's face. In some implementations of the system, the new visual layer comprises at least one of a facial adornment, a hairstyle layer, a 3D object, and an animated scene.

In some implementations of the system, the processors of the personal electronic device may also be configured to record data related to emotions of a user while viewing one or more of the modified images, and/or apply an augmented reality effect to the modified images of the series of images of the user's face, wherein the augmented reality effect is chosen by the artificial intelligence platform at least in part based on the recorded data related to emotions.

Another aspect of the invention relates to a method for applying an AR layer. The method may include receiving a series of original images of a user's face, detecting, in the series of images, at least one emotion of the user, in response to the at least one detected emotion of the user, modifying at least a portion of at least one image of the series of images of the user's face, and displaying, on a screen of a personal electronic device of the user, the modified images of the user's face.

In some implementations of the method, the modified images of the series of images of the user's face may be displayed in substantially real-time.

The method may include acquiring, by at least one video capture device associated with the personal electronic device, at least some of the series of original images of the user's face.

In some implementations of the method, modifying at least a portion of at least one image of the series of images of the user's face may comprise including at least one color associated with the at least one detected emotion of the user. In some implementations of the method, modifying at least a portion of at least one image of the series of images of the user's face may comprise at least one of: a color modification, an animation, and an addition of an object to at least one image of the series of images of the user's face.

In some implementations of the method, modifying at least a portion of at least one image of the series of images of the user's face may include applying a new visual layer to the at least one of the series of images of the user's face. In some implementations of the method, the new visual layer may include at least one of a facial adornment, a hairstyle layer, a 3D object, and an animated scene.

The method may include detecting a plurality of facial landmarks in at least one of the series of images of the user's face. In some implementations, the method may include generating a three-dimensional model of the user's face based, at least in part, on the plurality of detected landmarks.

Some implementations of the method may include recording data related to emotions of a user while viewing one or more of the modified images. Some implementations of the method may further include applying an augmented reality effect to the modified images of the series of images of the user's face, the augmented reality effect chosen at least in part based on the recorded data and a recommendation of an artificial intelligence platform.

Other technical features may be readily apparent to one skilled in the art from the following figures, descriptions, and claims. These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), solid state drives (SSDs), flash, or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates a high-level component diagram of an illustrative system according to some embodiments of this disclosure.

FIG. 2 illustrates a high-level block diagram of components and logical modules of an illustrative system according to some embodiments of this disclosure.

FIG. 3 illustrates examples of on-screen results of an illustrative system according to some embodiments of this disclosure.

FIG. 4 represents a flowchart for a method of emotion-based real-time personalization of augmented reality environments according to some embodiments of this disclosure.

FIG. 5 represents a flowchart for a method of real-time personalization of augmented reality environments based on demographic characteristics of a user, according to some embodiments of this disclosure.

FIG. 6 represents a flowchart for a method of emotion-based real-time personalization of augmented reality environments including constructing a three-dimensional digital model of a user's face, according to some embodiments of this disclosure.

FIG. 7 represents a flowchart for a method of emotion- or demographic-based real-time personalization of an augmented reality environment including using an artificial intelligence platform at least in part to choose an augmented reality effect.

### DETAILED DESCRIPTION

Enhancement and personalization of augmented reality environments are desired. Further improvements are desired with respect to personalizing an environment based on detected emotions, detected demographic characteristics, and other characteristics of a user of the augmented reality system. Further, it is desired that in some embodiments, all or a substantial amount of the computation should take place at a personal electronic device or otherwise on the “edge” in order to improve responsiveness and better enable a real-time effect unhindered by network latencies. In the case where personal data is processed and not stored, enhanced privacy would provide an additional advantage of the invention.

Some embodiments of the disclosure relate to the modification of real-time video by applying Augmented Reality filters on a person's face, such filters being personalized face characteristics of the user such as emotions, age, gender or other attributes such as the presence of a beard or glasses, among many other possibilities. In other embodiments, many of the principles disclosed herein may be applied in a system of adaptable digital signage that changes content based on the viewer. According to some embodiments, a user may have his or her face filmed by a camera integrated with or connected to a computer (such as a smartphone or a desktop PC), while the user is viewing a screen associated with the electronic device as the screen displays a video of that person with additional augmented reality effects.

One common use case for the disclosed inventions are live video “selfies” in which it is necessary or desirable that the AR filter be rendered substantially in real-time according to the user's perception. Such a system may be rendered at frame rate high enough to provide a fluid and realistic rendering. Co-location of computing components used for the face AI and AR modules in some implementations may help the system work in substantially real-time, avoiding propagation delays to and from remote computing resources.

Existing augmented reality systems typically are not capable of detecting emotion or demographic characteristics of a user, nor responding by altering the augmented reality experience or layer(s) to complement and/or reflect the detected characteristics. In addition, many augmented reality systems rely on cloud processing, which materially degrades performance and/or prevents a system from displaying complicated augmented reality scenes or layers in real-time.

Aspects of the present disclosure relate to embodiments that overcome the shortcomings described above. The present disclosure relates to providing systems and methods for improved augmented reality experiences including reactions to detected emotions and/or other facial characteristics of an end user. In some embodiments, an artificial intelligence system, also in real-time from the perspective of the user, and analyzes emotional reactions to the augmented reality environment. In some embodiments, the data analyzed by the artificial intelligence system is used to modify the augmented reality experience.

Modern artificial intelligence and machine learning bring exciting new technical, operational and heuristic insights and possibilities to the fields of discussion. It should also be understood that, as part of the portions of this disclosure related to data collection and analysis of individual users, that various artificial intelligence and/or machine learning principles, as would be apparent to one having ordinary skill in those fields, may be applied to determine the methods of and/or enhance the data analysis and/or uncover additional insights.

One specific application of the disclosures presented herein relates to the modification of real-time video by applying one or more augmented reality filters on a user's face, where such filters are personalized in response to characteristics of the user's face such as detected emotions, age, gender, physical facial features, or other characteristics as would be apparent to one having ordinary skill in the art. In some embodiments, the user's face would be captured by a video camera or other imaging device connected to or integrated with a computing system such as a personal electronic device of the user. A display screen of the electronic device shows a real-time video image of the user including augmented reality effects that are personalized based on the detected characteristics of that user as described above.

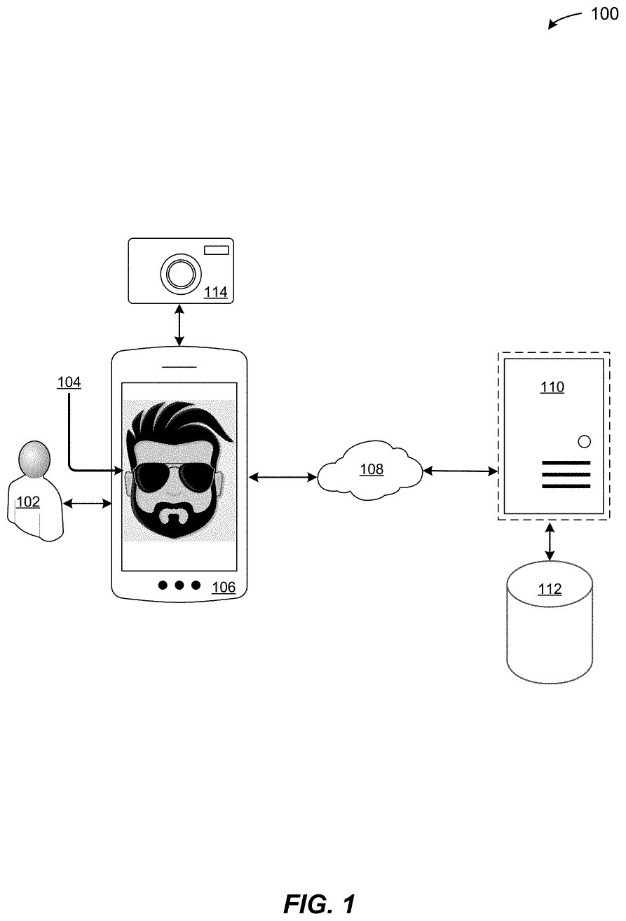

FIGS. 1 through 7, discussed below, and the various embodiments used to describe the principles of this disclosure are by way of illustration only and should not be construed in any way to limit the scope of the disclosure.

FIG. 1 illustrates a high-level component diagram of an illustrative system 100 according to some embodiments of this disclosure. A user 102 interacts with a user device 106. User device 106 may be any suitable computing device, such as a smartphone, tablet, or desktop or laptop computer.

A camera 114 is associated with user device 106. According to some embodiments, camera 114 may be integrated into the device itself. In other embodiments, camera 114 may be an external camera in wired or wireless communication with user device 106.

User device 106 according to some embodiments may also include a user display on which is displayed avatar 104. According to some embodiments, avatar 104 includes original imagery of the user 102 captured by camera 114, with an added Augmented Reality (“AR”) imagery layer.

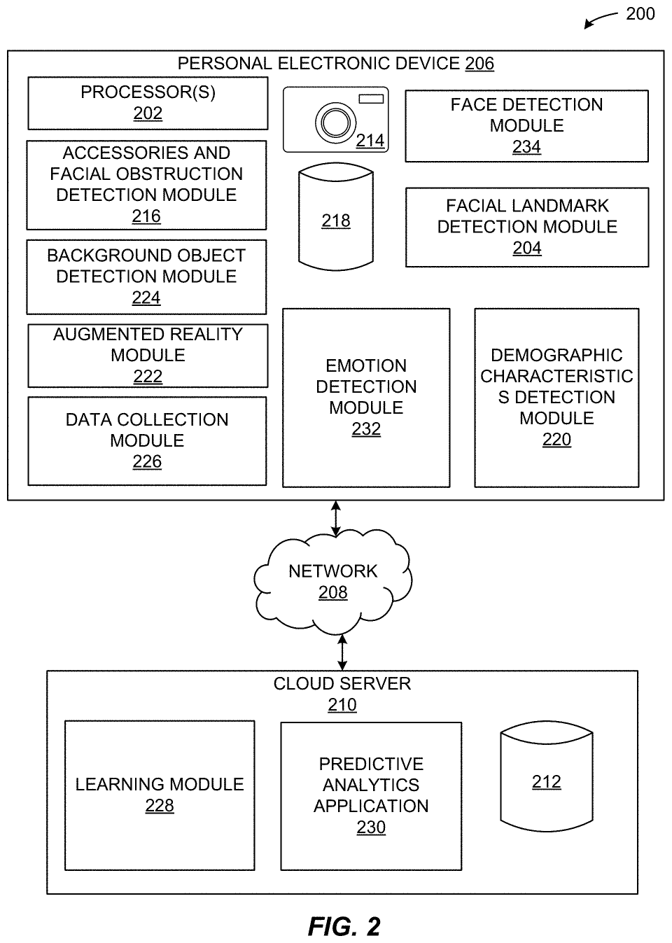

In some embodiments, user device 106 may be connected via a network 108 to a server 110 associated with a datastore 112. In some embodiments, server 110 may comprise a “big data” cloud server for collecting data necessary to run an AI learning capability as will be discussed in greater detail with reference to FIG. 2.

FIG. 2 illustrates a high-level block diagram of components and logical modules of an illustrative system 200 according to some embodiments of this disclosure.

As previously mentioned, in some embodiments, most or all of the calculations necessary to render the augmented reality layer take place on user device 206, which is illustrated at FIG. 2 as a personal electronic device. According to various embodiments, user device 206 includes one or more processors 202 for performing all computations required of the device and a data store 218, which may comprise any combination of appropriate nonvolatile and/or volatile storage media as would be apparent to one having ordinary skill in the art.

Camera 114 according to some embodiments may be integrated into user device 206 or a standalone camera connected to device 206 via a wireless or wired connection. Camera 114 captures video, or a series of images, of at least one users face and/or body.

According to some embodiments, the video may be analyzed frame-by-frame in substantially real-time, wherein the system for each frame extracts a photograph, regardless of the resolution available, and identifies one or more faces or body parts present in the picture.

According to some embodiments, each frame is then analyzed by face detection module 234 to determine whether one or more faces is present in the frame. According to some embodiments, face detection module 234 may return a rectangle or otherwise indicate an area of the image for each detected face, such information being useful to other modules, for example when it is desirable to apply an effect only to an area of a face or to areas NOT representing a face.

According to some embodiments, if at least one face is detected, facial landmark detection module 204 will then analyze the frame or frames to identify a number of face landmarks or anchors of each face present in the frame. According to some embodiments, facial landmark detection module 204 may detect between 50-150 landmarks for each face, collectively representing a number of features including but not limited to: contour of the lips, nose, eyes, eyebrows, oval of the face, and many other data points as would be apparent to one having ordinary skill in the art. According to some embodiments, facial movements may be tracked by analyzing movements of landmarks with respect to the previous frame. In other embodiments, advanced AI techniques utilizing neural networks or other methods such as machine learning and/or deep learning algorithms may be able to detect emotions without the explicit facial landmark detection.

According to some embodiments, a specialized emotion detection module 232 may be configured to analyze frames of the video stream and detect emotions in the face. According to some embodiments, an artificial intelligence system such as a neural network or other suitable system may be used to perform the emotion detection.

According to various embodiments, demographic characteristics such as age, gender, ethnicity, or other features of the face and/or body may be detected by demographic characteristics module 220. According to some embodiments, this module may also include an artificial intelligence and/or neural network component, or may employ more traditional algorithms

Still further detection may be performed in some embodiments by the accessories and facial obstruction detection module 216. For example, the presence and shape of hair or facial hair may be detected. Accessories such as a hat, glasses, facial jewelry, etc. may also be detected by this module.

According to some embodiments, another such specialized component, the background object detection module 224, may detect additional elements external to the face(s) of the participants. For example, any elements external to the face such as the user's body or a background scene where the face is present may be detected by this module.

Each of these face AI modules described above according to various embodiments may provide data about the characteristics of the detected face or the scene. Such modules may work in parallel to provide a set of information that can be used to modify or enhance the scene in real-time. All or part of this data may be collected by data collection module 226.

According to some embodiments, a 3D augmented reality module 222 may be activated to calculate and render a computer graphics AR layer onto the scene on the screen connected to or integrated with device 206. For example, the face imagery captured by the camera may be merged with the background and displayed in combination with the AR layer on device 206. According to various embodiments, The AR graphic layer can be placed in any position and can involve any element present in the scene, either on the face, on the body, in the area surrounding the face or in the background, or the foreground.

The data supplied by the various modules discussed above is in some embodiments, then used by augmented reality module 222 to personalize and adapt the computer graphic layers applied to the face or to other components of the scene involving the user's face. According to some embodiments, these layers are then created and animated in correlation with one or more of: the face detected, the facial movements detected by the tracker, face characteristics detected by the various specific modules, and the surrounding original or modified scene.

According to some embodiments, all of the chosen elements provide information that is used to create the new image. While this processing is happening locally on the device, according to some embodiments, the user facing the camera sees themselves on the screen of the device acting as a virtual mirror in real-time.

These examples should in no way be considered exhaustive, as they are provided solely to show the breadth of the concept of real-time personalization of AR filters and how it applies to transform AR into a more meaningful, subtle, and engaging experience than any similar system that has previously been available.

Some example transformations according to various embodiments include: Filter colors change to lively colors when the user's emotions are sad or angry to provide a positive message. Vice versa, filters' colors change to neutral colors when the user expresses positive emotions.

(a) Glasses are applied in AR on the user's face. Their style depends on the user's age & gender.

(b) An animation of the scene around the user's face, such as the movement of a 3D object, is triggered (i.e. it starts if & when an event occurs) when the user smiles.

(c) An object appears only if a face characteristic is detected: for instance, a razor shows up in the scene if a beard or moustache are detected. Such personalization may be relevant, e.g., for shaving equipment brands to create innovative personalized experiences which can be sponsored, as a new kind of commercial advertising.

(d) A 3D animation of a creature depicting, for instance, a virus such as the Corona Covid-19, could have facial expressions reacting to the user's emotions: when the user is afraid, the virus displays an aggressive mood, when the user is angry, the virus displays fear, when the user is slightly happy, the virus shows signs of stress, when the user is very happy, the virus dies. Such digital experiences could be used in campaigns aiming to give psychological support to the healthcare community involved in fighting the virus.

(e) A filter with a flower crown only appears to girls between 15 and 25. A filter with a smoking pipe and a cowboy hat appears to boys in the same age group.

(f) Lights sources illuminate the scene changing according to emotional state.

In order to maintain fluid rending according to some embodiments, all or most of the processes above may be repeated on each and every frame of the video flow in real-time.

The capability to detect people's emotions, gender, age and ethnicity face characteristics when they are exposed to AR filters enables to collect data on their preferences by demographics: by categorizing AR filters and by measuring the emotional reaction of users by age group, gender and ethnicity provides big data that enables to predict future emotional responses of people of any age, gender & ethnicity to other AR filters. For instance: applying different types of Eyewear models in AR to a sufficiently large number of users' faces while detecting their emotions, gender, age, etc. creates a database of preferences, provided eyewear models are categorized in (for instance) classic, sporty aviator, circle round, vintage cat eye, fashion, with male, female models for each category, etc.

To further describe the big data aspect of this invention according to some embodiments, Data Collection Module 226 runs on the device where the user is exposed to the AR experiences and collects all the data (provided by the specialized Face AI components) on emotions, gender and age (and possibly more) as well as the type & category of AR filter (for instance glasses & the category). Such data is collected locally according to some implementations, and then sent (in real time or asynchronously) via network 208 to a Cloud Server 210 which will store big data coming from possibly a large number of devices on which such Data Collection Modules are running into a database 212.

A learning module 228 may be implemented according to some embodiments on the Cloud Server by running a Predictive Analytics application 230 based on big data AI making use of all the collected data to predict (for instance) what will be the emotional reaction of (for instance) male in the age group 25-35 to a new model of Glasses of a given category.

Collecting such reactions is an important part of the process of improvement according to some embodiments. Going further in the personalization, some embodiments may take advantage of a learning capability based on a big data storage to provide feedback to the AR filters application on the devices so that it adapts the filter to the age and gender of the person facing the device camera. Suppose, for example, that there was information gleaned from the questions that we learnt that male in the 25-35 age group gave the most positive response to the “Sporty Aviator” category of glasses. This information, adequately coded, is sent from the Cloud Server to each device to display such AR filters to the user. To minimize network traffic and avoid delays, the Server produces the results of its predictive analytics to the distributed AR Applications in the form of a local Learning Base containing the preference data, a small data set of (in this example) the types of filters, the different categories and the preferences of users by gender, age, ethnicity, etc. With such a feedback loop now closed, AR applications now have the current state of learning locally stored in their learning base of what AR filter they should deliver to each category of user in order to have the highest chance to cause a given emotional response.

According to some embodiments, as the AR module runs, users may apply filters on their faces, expressing different emotions for a variety of reasons and experience a variety of changes as a result. According to some embodiments, all of this information will be capture by Data Collection module 226. For analytics updates.

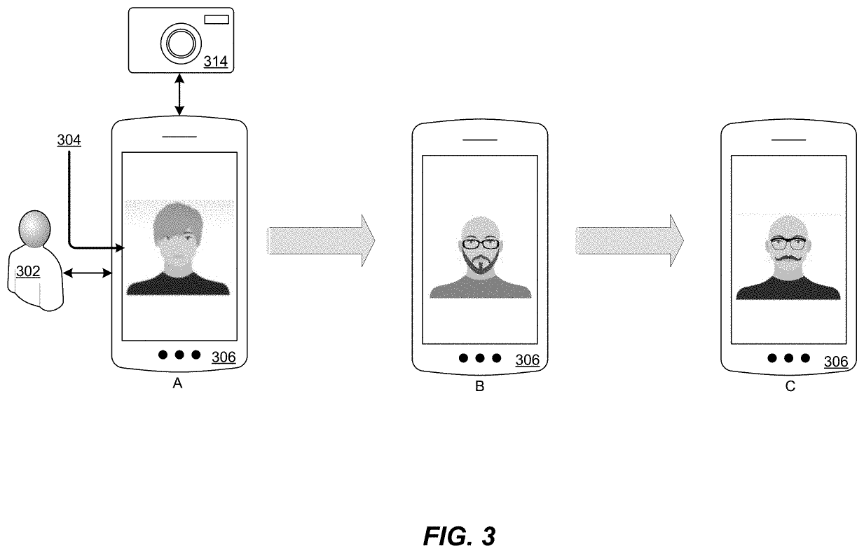

FIG. 3 illustrates examples of on-screen results of an illustrative system 300 according to some embodiments of this disclosure. User 302 interacts with user device 306. User 302's face is capture by a camera 314 and, at phase A, may be displayed more or less as it appears.

At phase B of FIG. 3, an AR layer has created the illusion of having removed user 302's hair, changing user 302's shirt color, and adding both a beard and glasses to the image or avatar 304 of user 302 displayed on the personal electronic device.

At phase C of FIG. 3, according to some embodiments, user 302's face has been altered once again, keeping the appearance of a bald or shaved head and the glasses, user 302's shirt color has changed again and the user's beard has been swapped for a mustache.

Such example transformations, besides being valuable as entertainment, may be useful to brands wishing to offer a virtual try-on experience to their customers.

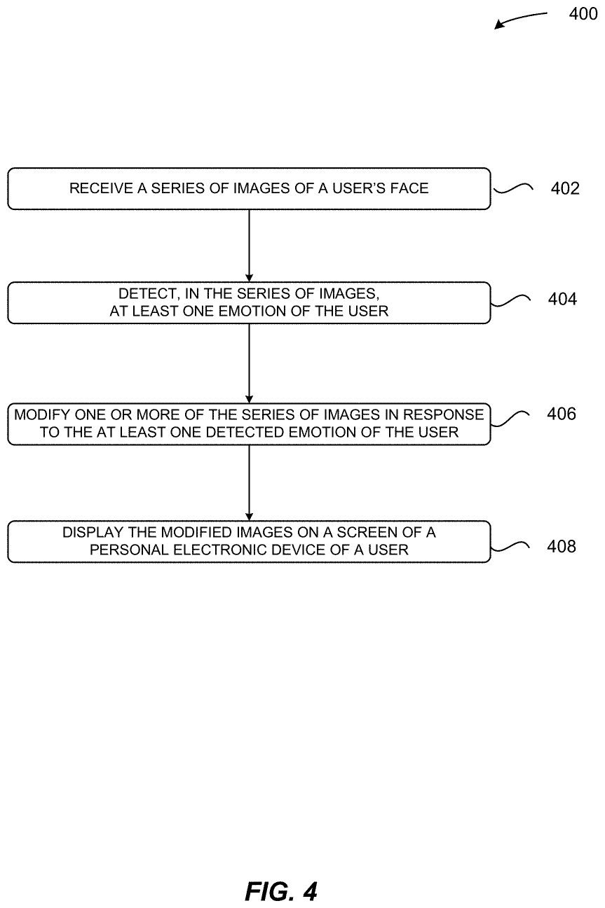

FIG. 4 represents a flowchart 400 for a method of emotion-based real-time personalization of augmented reality environments according to some embodiments of this disclosure.

At step 402, a series of images of a user's face are received. According to some embodiments, these may be captured from a camera as described above. According to some embodiments, a user may have his or her face filmed by a camera integrated with or connected to a computer (such as a smartphone or a desktop PC), while the user is viewing a screen associated with the electronic device as the screen displays a video of that person with additional augmented reality effects.

At step 404 according to some embodiments, at least one emotion of a user may be detected. According to some embodiments, this step may be performed on a user device by an emotion detection module 232 or equivalent functionality as described above with reference to FIG. 2.

At step 406, one or more of the series of images is modified in response to the detected emotion. Examples of some such modifications according to various embodiments may be found in the detailed descriptions above related to FIG. 2.

At step 408, the modified images are displayed on a screen of a user device. According to some embodiments, such displays may be represented, for example, by FIGS. 1 and 3 as described in detail herein.

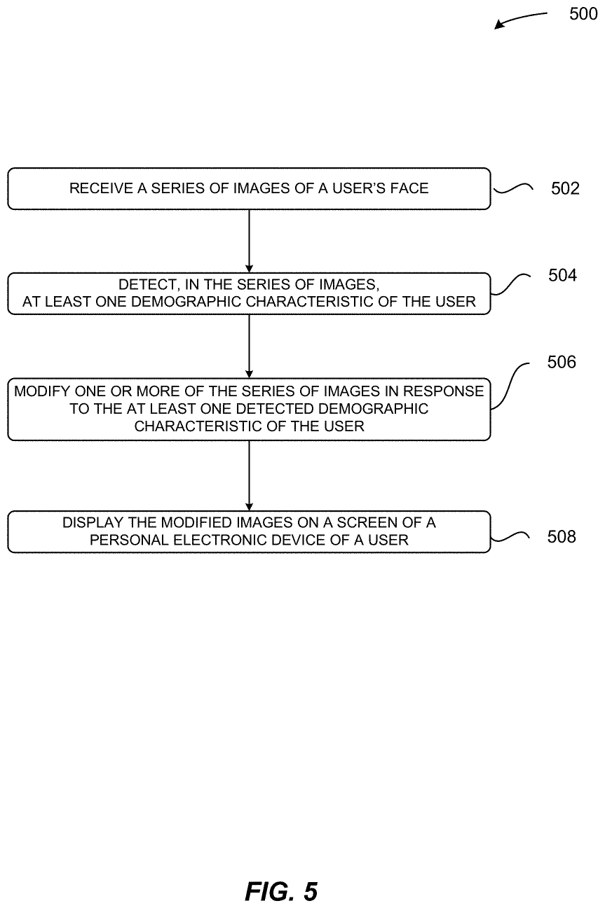

FIG. 5 represents a flowchart 500 for a method of real-time personalization of augmented reality environments based on demographic characteristics of a user, according to some embodiments of this disclosure.

At step 502, a series of images of a user's face are received. According to some embodiments, these may be captured from a camera as described above. According to some embodiments, a user may have his or her face filmed by a camera integrated with or connected to a computer (such as a smartphone or a desktop PC), while the user is viewing a screen associated with the electronic device as the screen displays a video of that person with additional augmented reality effects.

At step 504 according to some embodiments, at least one demographic characteristic of a user may be detected. According to some embodiments, this step may be performed on a user device by a demographic characteristics detection module or equivalent functionality as described above with reference to FIG. 2.

At step 506, one or more of the series of images is modified in response to the detected demographic characteristic. Examples of some such modifications according to various embodiments may be found in the detailed descriptions above related to FIG. 2.

At step 508, the modified images are displayed on a screen of a user device. According to some embodiments, such displays may be represented, for example, by FIGS. 1 and 3 as described in detail herein.

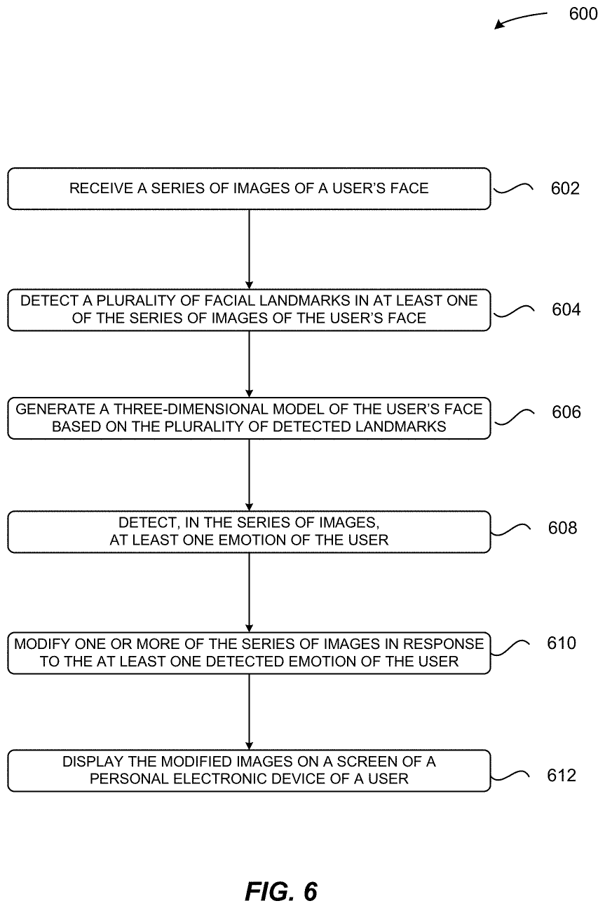

FIG. 6 represents a flowchart 600 for a method of emotion-based real-time personalization of augmented reality environments including constructing a three-dimensional digital model of a user's face, according to some embodiments of this disclosure.

At step 602, a series of images of a user's face are received. According to some embodiments, these may be captured from a camera as described above. According to some embodiments, a user may have his or her face filmed by a camera integrated with or connected to a computer (such as a smartphone or a desktop PC), while the user is viewing a screen associated with the electronic device as the screen displays a video of that person with additional augmented reality effects.

At step 604, a plurality of facial landmarks are detected in the series of images of the user. According to some embodiments, this step may be performed on a user device by a facial landmark detection module or equivalent functionality as described in detail with reference to FIG. 2.

At step 606, a 3D model of the user's face is generated based on the plurality of detected landmarks. As with step 604 above, more detail of the step according to some embodiments may be found at detailed description paragraphs above dedicated to FIG. 2.

At step 608 according to some embodiments, at least one emotion of a user may be detected. According to some embodiments, this step may be performed on a user device by an emotion detection module 232 or equivalent functionality as described above with reference to FIG. 2.

At step 610, one or more of the series of images is modified in response to the detected emotion. Examples of some such modifications according to various embodiments may be found in the detailed descriptions above related to FIG. 2.

At step 612, the modified images are displayed on a screen of a user device. According to some embodiments, such displays may be represented, for example, by FIGS. 1 and 3 as described in detail herein.

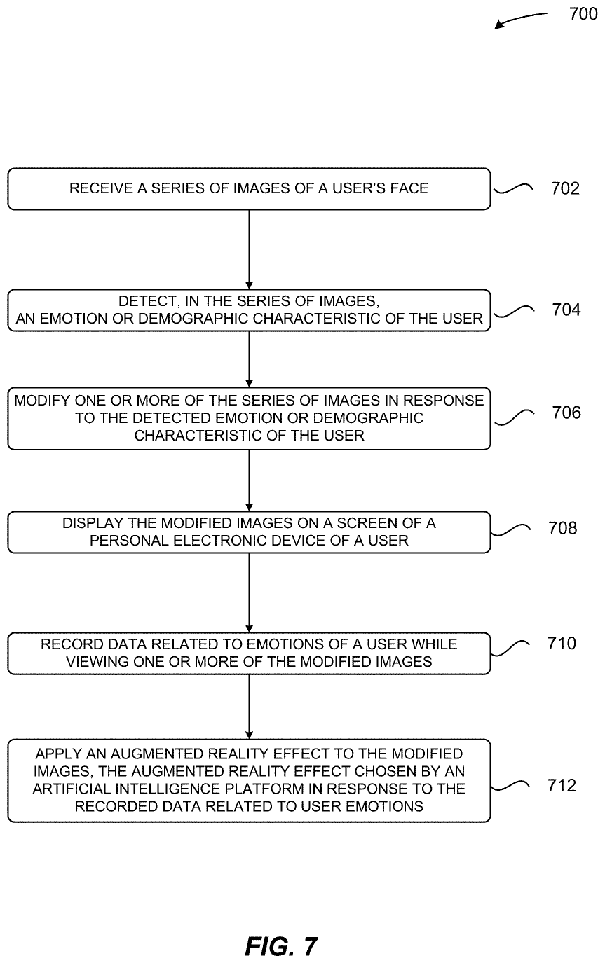

FIG. 7 represents a flowchart 700 for a method of emotion- or demographic-based real-time personalization of an augmented reality environment including using an artificial intelligence platform at least in part to choose an augmented reality effect.

At step 702, a series of images of a user's face are received. According to some embodiments, these may be captured from a camera as described above. According to some embodiments, a user may have his or her face filmed by a camera integrated with or connected to a computer (such as a smartphone or a desktop PC), while the user is viewing a screen associated with the electronic device as the screen displays a video of that person with additional augmented reality effects.

At step 704 according to some embodiments, at least one emotion of a user may be detected. According to some embodiments, this step may be performed on a user device by an emotion detection module 232 or equivalent functionality as described above with reference to FIG. 2.

At step 706, one or more of the series of images is modified in response to the detected emotion. Examples of some such modifications according to various embodiments may be found in the detailed descriptions above related to FIG. 2.

At step 708, the modified images are displayed on a screen of a user device. According to some embodiments, such displays may be represented, for example, by FIGS. 1 and 3 as described in detail herein.

At step 710, data is recorded relating to emotions of the user detected in response to seeing the AR layers integrated onto the user's screen. According to some embodiments, this data may be recorded by a data collection module 226 (see detailed description of FIG. 2 above) or equivalent functionality as one having ordinary skill in the art would understand.

At step 712, an artificial intelligence platform chooses and deploys a modified augmented reality effect in response to the AI logic calculating that modifications to the AR layer(s) are necessary or desirable.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle.

What is claimed is:

1. A system comprising:
a personal electronic device operated by a user;
one or more hardware processors of the personal electronic device, the one or more hardware processors configured by machine-readable instructions to:
receive a series of original images of the user's face;
detect, in the series of images, at least one emotion of the user;
in response to the at least one detected emotion of the user, modify at least a portion of at least one image of the series of images of the user's face; and
display, on a screen of the personal electronic device, the modified images of the series of images of the user's face.

2. The system of claim 1, wherein the modified images of the series of images of the user's face are displayed in substantially real-time.

3. The system of claim 1, further comprising at least one video capture device associated with the personal electronic device, the at least one video capture device configured to acquire at least some of the series of original images of the user's face.

4. The system of claim, 1, wherein the series of original images of the user's face comprises at least a portion of a pre-recorded video of the user's face.

5. The system of claim 1, wherein modifying at least a portion of at least one image of the series of images of the user's face comprises at least one of: a color modification, an animation, and an addition of an object to at least one image of the series of images of the user's face.

6. The system of claim 1, wherein modifying at least a portion of at least one image of the series of images of the user's face comprises applying a new visual layer to the at least one of the series of images of the user's face.

7. The system of claim 6, wherein the new visual layer comprises at least one of a facial adornment, a hairstyle layer, a 3d object, and an animated scene.

8. The system of claim 1, wherein the one or more hardware processors are further configured to:
detect a plurality of facial landmarks in at least one of the series of images of the user's face;
generate a three-dimensional model of the user's face based, at least in part, on the plurality of detected landmarks.

9. The system of claim 1, wherein the one or more hardware processors of the personal electronic device are further configured to:
record data related to emotions of a user while viewing one or more or the modified images; and
apply an augmented reality effect to the modified images of the series of images of the user's face, the augmented reality effect chosen by an artificial intelligence platform at least in part based on the recorded data related to emotions.

10. The system of claim 1, wherein the one or more hardware processors of the personal electronic device are further configured to:
transmit data for storage associated with an artificial intelligence platform, the data related to one or more of: facial characteristics of the user, detected emotions of the user, and demographic information about the user; and
receive predictive analytics data from the artificial intelligence platform, wherein the predictive analytics data is related to expected emotions of various users categorized by types of AR filters and demographic information.

11. The system of claim 1, wherein the artificial intelligence platform comprises:
a cloud server; and
a deep learning module.

12. A method comprising:
receiving a series of original images of a user's face;
detecting, in the series of images, at least one emotion of the user;
in response to the at least one detected emotion of the user, modifying at least a portion of at least one image of the series of images of the user's face; and
displaying, on a screen of a personal electronic device of the user, the modified images of the user's face.

13. The method of claim 12, wherein the modified images of the series of images of the user's face are displayed in substantially real-time.

14. The method of claim 12, wherein the method further comprises acquiring, by at least one video capture device associated with the personal electronic device, at least some of the series of original images of the user's face.

15. The method of claim 12, wherein modifying at least a portion of at least one image of the series of images of the user's face comprises at least one of: a color modification, an animation, and an addition of an object to at least one image of the series of images of the user's face.

16. The method of claim 12, wherein modifying at least a portion of at least one image of the series of images of the user's face comprises applying a new visual layer to the at least one of the series of images of the user's face.

17. The method of claim 12, wherein the new visual layer comprises at least one of a facial adornment, a hairstyle layer, a 3d object, and an animated scene.

18. The method of claim 12, wherein the one or more hardware processors are further configured to:
detect a plurality of facial landmarks in at least one of the series of images of the user's face;
generate a three-dimensional model of the user's face based, at least in part, on the plurality of detected landmarks.

19. The method of claim 12, wherein the one or more hardware processors of the personal electronic device are further configured to:
record data related to emotions of a user while viewing one or more of the modified images; and
apply an augmented reality effect to the modified images of the series of images of the user's face, the augmented reality effect chosen at least in part based on the recorded data and a recommendation of an artificial intelligence platform.

20. A system comprising:
a personal electronic device operated by a user;
at least one video capture device configured to acquire a series of images of the user's face;
one or more hardware processors of the personal electronic device, the one or more hardware processors configured by machine-readable instructions to:
detect at least one demographic characteristic of the user;
at least in part in response to the at least one detected demographic characteristic of the user, modify at least a portion of a background of at least one of the series of images of the user's face; and
display, on a screen of the personal electronic device, the modified images of the series of images of the user's face.

21. The system of claim 20, wherein the modified images of the series of images of the user's face are displayed in substantially real-time.

22. The system of claim 15, wherein modifying at least a portion of at least one image of the series of images of the user's face comprises a modification associated with at least one of the user's age, gender, or ethnicity.

23. The system of claim 15, wherein modifying at least a portion of a background of at least one of the series of images of the user's face comprises applying a new visual layer to the at least one of the series of images of the user's face.

24. The system of claim 15, wherein modifying at least a portion of at least one image of the series of images of the user's face comprises applying a new visual layer to the at least one of the series of images of the user's face.

25. The system of claim 15, wherein the one or more hardware processors are further configured to:
detect a plurality of facial landmarks in at least one of the series of images of the user's face;
generate a three-dimensional model of the user's face based, at least in part, on the plurality of detected landmarks.

26. The system of claim 15, wherein the one or more hardware processors of the personal electronic device are further configured to:
record data related to emotions of a user while viewing one or more or the modified images; and
apply an augmented reality effect to the modified images of the series of images of the user's face, the augmented reality effect chosen by an artificial intelligence platform at least in part based on the recorded data related to emotions.
